(19) United States
(12) Patent Application Publication
(10) Pub. No.: US 2026/0277154 A1
(43) Pub. Date: Sep. 17, 2026

(54) IMAGE FORMING APPARATUS

(71) Applicant: Takeshi Sakashita, Tokyo (JP)

(72) Inventor: Takeshi Sakashita, Tokyo (JP)

(73) Assignee: ETRIA Co., Ltd., Kanagawa (JP)

(21) Appl. No.: 19/560,299

(22) Filed: Mar. 9, 2026

(30) Foreign Application Priority Data
Mar. 14, 2025 (JP) 2025-041347

(51) Int. Cl. G03G 21/20; G03G 15/00

(52) U.S. Cl. CPC G03G 21/206; G03G 15/6552; G03G 15/6573; G03G 2215/00421

(57) ABSTRACT

An image forming apparatus includes an image former, a sheet stacker, a lateral projection, a blower, and a pressing member. The sheet stacker is disposed above the image former in a vertical direction. The lateral projection projects upward from the image former in the vertical direction, and is disposed at a side portion of the image former in a lateral direction perpendicular to the vertical direction. The blower includes multiple exhaust ports arranged side by side at intervals in a width direction perpendicular to the vertical direction and the lateral direction. The pressing member contacts and presses, an upper surface of the sheet ejected from the sheet ejection port to the sheet stacker, from above in the vertical direction. The pressing member is disposed within an operating region between two adjacent exhaust ports among the multiple exhaust ports in the width direction.

### CROSS-REFERENCE TO RELATED APPLICATIONS

This patent application is based on and claims priority pursuant to 35 U.S.C. § 119(a) to Japanese Patent Application No. 2025-041347, filed on Mar. 14, 2025, in the Japan Patent Office, the entire disclosure of which is hereby incorporated by reference herein.

### BACKGROUND

### Technical Field

The present disclosure relates to an image forming apparatus such as a copier, a printer, a facsimile machine, or a multifunction peripheral (MFP) having at least two of such capabilities.

### Related Art

Image forming apparatuses, such as copiers and printers, have been developed. Such image forming apparatuses eject, after image formation, a sheet from a lateral projection projecting upward from a side portion of an image former, and place (stack) the sheet on a sheet stacker located above the image former.

### SUMMARY

An embodiment of the present disclosure provides an image forming apparatus includes an image former, a sheet stacker, a lateral projection, a blower, and a pressing member. The image former forms an image on a sheet. The sheet stacker is disposed above the image former in a vertical direction. The sheet stacker is used to stack the sheet having the image on the sheet. The lateral projection projects upward from the image former in the vertical direction, and is disposed at a side portion of the image former in a lateral direction perpendicular to the vertical direction. The lateral projection is disposed adjacent to the sheet stacker in the lateral direction; and includes a sheet ejection port to eject the sheet to the sheet stacker in the lateral direction. The blower includes multiple exhaust ports arranged side by side at intervals in a width direction perpendicular to the vertical direction and the lateral direction. The multiple exhaust ports are disposed above the sheet ejection port to exhaust air downward to the sheet stacker. The pressing member contacts and presses, an upper surface of the sheet ejected from the sheet ejection port to the sheet stacker, from above in the vertical direction. The pressing member is disposed within an operating region between two adjacent exhaust ports among the multiple exhaust ports in the width direction.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a schematic diagram illustrating an overall configuration of an image forming apparatus;

FIG. 2 is a perspective view of an image forming apparatus;

FIG. 3 is a diagram of the vicinity of a sheet stacker;

FIG. 4 is a top view of airflow in a duct of a blower;

FIG. 5 is a front view, as viewed from downstream in a sheet ejection direction, illustrating a relative position in a width direction of a sheet between an exhaust port of a blower and a hold-down member;

FIG. 6 is a cross-sectional view of a duct taken along line F-F in FIG. 5;

FIGS. 7A, 7B, 7C, and 7D are diagrams illustrating an operation in which sheets are ejected onto a sheet stacker;

FIG. 8 is a block diagram of a part of a configuration of an image forming apparatus;

FIG. 9 is a diagram illustrating a configuration of a control system of an image forming apparatus;

FIG. 10 is a front view, as viewed from downstream in a sheet ejection direction, illustrating a relative position in a width direction of a sheet between exhaust ports of a blower and a hold-down member in an image forming apparatus according to Modification 1;

FIG. 11 is a top view of airflow in a duct of a blower, according to Modification 2;

FIG. 12 is a flowchart of control performed in an image forming apparatus according to Modification 3; and

FIGS. 13A, 13B, 13C, and 13D are diagrams illustrating an operation of the image forming apparatus according to Modification 3 during execution of the control of FIG. 12.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

According to one aspect of the present disclosure, an image forming apparatus can be achieved in which sheets ejected from the sheet ejection port are stacked on the sheet stacker without sticking together due to heat.

Embodiments of the present disclosure are described below in detail with reference to the drawings. In the drawings, like reference signs denote like elements, and overlapping descriptions may be simplified or omitted as appropriate.

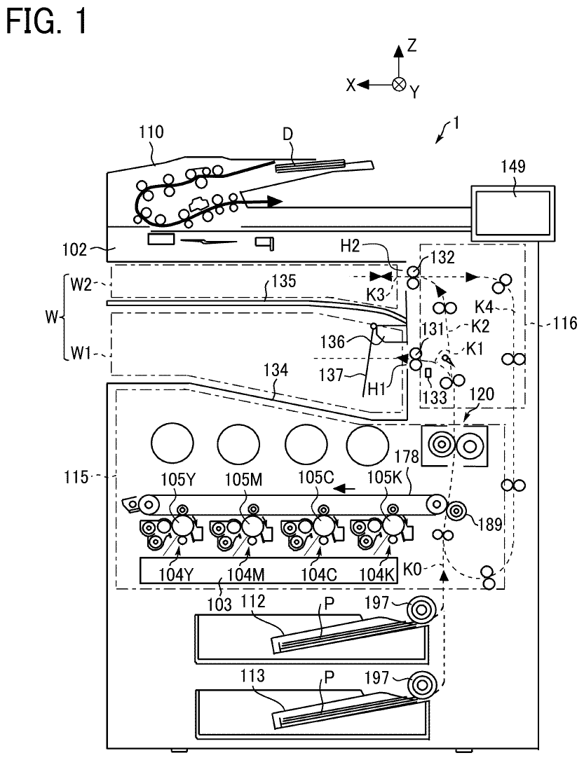

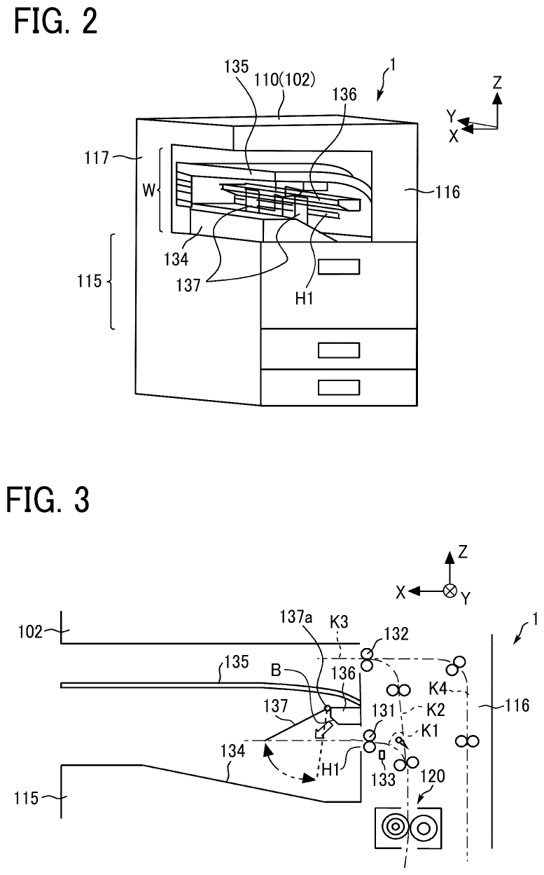

With reference to FIGS. 1 and 2, the overall configuration and operation of an image forming apparatus 1 are described. FIG. 1 is a schematic diagram illustrating an overall configuration of an image forming apparatus 1. FIG. 2 is a perspective view of the image forming apparatus 1.

As illustrated in FIGS. 1 and 2, the image forming apparatus 1 has an internal space W formed below a document feeder 110 and a document reader 102 and above an image former 115. The internal space W is surrounded by a lateral projection 116 and a rear projection 117. The lateral projection 116 is a lateral wall, and the rear projection 117 is a rear wall.

The internal space W is a space in which a sheet P ejected from the image forming apparatus 1 after image formation or printing is received and stacked, and from which the sheet P ejected from the image forming apparatus 1 is taken out.

The internal space W includes a first space W1 and a second space W2 located above the first space W1. The first space W1 and the second space W2 are partitioned by a second sheet stacker 135 (or a reversing tray).

The first space W1 includes a first sheet stacker 134 having a sheet placement surface on which sheets P are sequentially stacked after printing.

The second space W2 is a space in which the sheet P is temporarily ejected to flip the sheet P after a front side of the sheet P is printed in duplex mode. In the present embodiment, the second space W2 serves as a space that allows the sheets P after printing to be stacked at a location different from the first sheet stacker 134. In such a case, the sheets P after printing are sequentially stacked on the second sheet stacker 135, i.e., the reversing tray.

The internal space W is provided with a blower 136 and a hold-down member 137. The hold-down member 137 is an example of a pressing member. The blower 136 cools the sheets P stacked on the first sheet stacker 134. The hold-down member 137 is used to increase the stackability of the sheets P ejected into the internal space W. Details of the blower 136 and the hold-down member 137 will be described later.

As illustrated in FIG. 1, the image forming apparatus 1 includes the image former 115, apparatus-body sheet feed trays 112 and 113, the lateral projection 116, the rear projection 117 (see FIG. 2), the document feeder 110, and the document reader 102. The image former 115 and the apparatus-body sheet feed trays 112 and 113 are disposed below the internal space W, i.e., in the −Z direction. The lateral projection 116 is disposed on a lateral side of the internal space W, i.e., in the −X direction (the right side in FIG. 1). The rear projection 117 is disposed on a rear side of the internal space W, i.e., in the +Y direction (a direction perpendicular to the plane of the sheet of FIG. 1). The document feeder 110 and the document reader 102 are disposed above the internal space W.

The image former 115 is provided with a writing device 103, image formation units 104Y, 104M, 104C, and 104K, an intermediate transfer belt 178, a secondary transfer roller 189, and a fixing device 120.

Additionally, the exterior of the image forming apparatus 1 is equipped with an operation display panel 149 (operation display section) for displaying various information related to the image forming apparatus 1 and for inputting various commands. The front (near) side of the image forming apparatus 1 is the side on which an operator (e.g., a user) faces the operation display panel 149 for operation or display viewing.

The internal space W is open on the front side and on the left side of the image forming apparatus 1 as viewed from the front side of the image forming apparatus 1.

In the following description, the image forming operation (or printing operation) of the image forming apparatus 1 is described below with reference to FIG. 1.

Firstly, multiple rollers of the document feeder 110 convey or feed a document D from a document tray in a direction indicated by arrow in FIG. 1. The document D thus conveyed passes over the document reader 102. At this time, the document reader 102 optically reads image data of the document D passing over the document reader 2.

The image data optically read by the document reader 102 is converted into electrical signals. The electrical signals are transmitted to the writing device 103 serving as a writer. Then, the writing device 103 emits laser beams, based on the image data represented by the electrical signals, toward the photoconductor drums 105Y, 105M, 105C, and 105K for the respective colors, performing an exposure process.

Then, the charging, exposure, and development processes are performed on the photoconductor drums 105Y, 105M, 105C, and 105K of the respective image formation units 104Y, 104M, 104C, and 104K, resulting in the desired images being formed on the photoconductor drums 105Y, 105M, 105C, and 105K.

Subsequently, the images formed on the photoconductor drums 105Y, 105M, 105C, and 105K are superimposed and transferred onto the intermediate transfer belt 178 as a color image. Furthermore, the sheet P is fed from either one of the apparatus-body sheet feed trays 112 and 113 by feeding rollers 197 and conveyed along a sheet feeding path K0. At an opposing position (a secondary transfer nip) between the intermediate transfer belt 178 and the secondary transfer roller 189, the color image formed on the intermediate transfer belt 178 is transferred onto the sheet P. Thereafter, the sheet P onto which the color image is transferred is conveyed to the fixing device 120. Then, the multicolor toner image transferred onto a surface of the sheet P is fixed on the sheet P (a fixing process).

After the image is formed by the image former 115, the sheet P after printing is conveyed through a first sheet ejection path K1 (a sheet ejection path) in the lateral projection 116, and is ejected from a first sheet ejection port H1 (a sheet ejection port) by a first ejection roller pair 131. As a result, the sheet P is stacked on the first sheet stacker 134 (sheet stacker) in the first space W1.

When a single-side printing mode is selected, the sheet P is ejected from the image forming apparatus 1 after a toner image is fixed on a front side of the sheet P. By contrast, when a duplex printing mode to print toner images on both sides, namely the front side and a back side, of the sheet P is selected, the sheet P after completion of a fixing process on the front side is guided, by operation of a switching claw, to a second sheet ejection path K2 (a sheet relay path), without being ejected from the image forming apparatus 1 as in a case where the single-side printing mode is selected. Then, the sheet P guided to the second sheet ejection path K2 is directed to a sheet reversing path K3. At this time, sheet P is ejected into the second space W2 from a second sheet ejection port H2, with the trailing end of the sheet P nipped between second ejection rollers 132 (reversing rollers) and the remaining portion ejected into the second space W2. After that, the sheet P is redirected by reverse rotation of the second ejection rollers 132 and is conveyed toward a duplex-printing conveyance path K4.

Subsequently, the sheet P guided to the duplex-printing conveyance path K4 is conveyed again to the secondary transfer nip at the secondary transfer roller 189. Then, at the second transfer nip, through image formation operations similar to those described above, a toner image is formed (printed) on a back side of the sheet P and is fixed thereon by the fixing device 120. After the fixing process by the fixing device 120, the sheet P is conveyed through the first sheet ejection path K1 and is ejected from the first sheet ejection port H1 into the first space W1, being stacked on the first sheet stacker 134.

The configuration and operation of the image forming apparatus 1 are described in further detail below.

As described with reference to FIGS. 1 and 2, the image forming apparatus 1 includes the image former 115, the lateral projection 116, the rear projection 117, the first sheet stacker 134 as the sheet stacker, the second sheet stacker 135, i.e., the reversing tray, the blower 136, and the hold-down member 137.

The image former 115 forms an image on the sheet P.

The first sheet stacker 134, serving as a reversing tray, is disposed above the image former 115. The first sheet stacker 134 allows the sheets P, on which the images have been formed by the image former 115, to be stacked thereon. The first sheet stacker 134 has an inclined surface (a sheet placement surface) that tilts upward from upstream to downstream in a sheet ejection direction (e.g., the +X direction) in which the sheet P is ejected onto the first sheet stacker 134.

FIG. 3 is a diagram of the vicinity of the sheet stacker 134. As illustrated in FIGS. 1 and 3, the second sheet stacker 135 (the reversing tray) is surrounded by the lateral projection 116 and the rear projection 117 above the space W (the first space W1) that functions as the first sheet stacker 134. The second sheet stacker 135 is a tray-shaped member having a curved portion adjacent to the lateral projection 116.

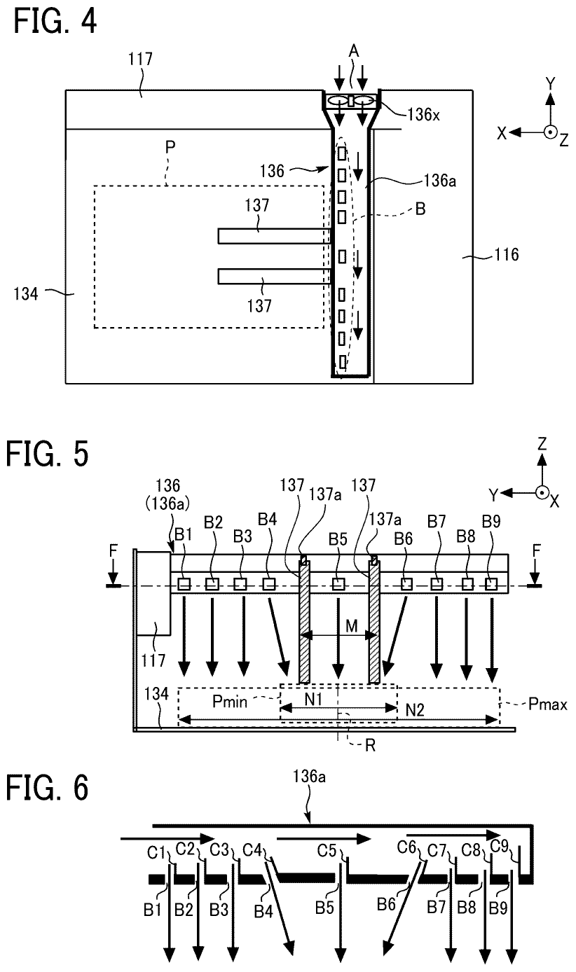

FIG. 4 is a top view of airflow in the duct 136a of the blower 136. As illustrated in FIGS. 1 to 4, the lateral projection 116 projects upward from a right side portion of the image former 115 (in the −X direction) and is adjacent to both the first sheet stacker 134 and the second sheet stacker 135.

The lateral projection 116 is provided with: the first sheet ejection path K1 serving as a sheet ejection path that conveys a sheet P on which an image has been formed by the image former 115; the first sheet ejection port H1 serving as a sheet ejection port to eject the sheet P toward the first sheet stacker 134; the second sheet ejection path K2 that conveys the sheet P on which an image has been formed by the image former 115; and the second sheet ejection port H2 to eject the sheet P toward the second sheet stacker 135. At the first sheet ejection port H1 (a sheet ejection port), the first ejection roller pair 131 is disposed to convey the sheet P toward the first sheet stacker 134 by nipping the sheet P.

The image former 115 and the lateral projection 116 may be arranged to at least partially overlap in the vertical direction at a lateral end of the image forming apparatus 1 in the width direction (X direction; left-right direction in FIG. 1). In some embodiments, the image former 115 and the lateral projection 116 may be arranged side by side in the width direction of the image forming apparatus.

The rear projection 117 projects upward from the rear side of the image former 115 or the image forming apparatus 1 in the +Y direction and is adjacent to both the first sheet stacker 134 and the second sheet stacker 135. The rear projection 117, together with the image former 115 and the lateral projection 116, defines the internal space W that functions as the first sheet stacker 134 and the second sheet stacker 135.

The image former 115 and the rear projection 117 may be arranged to at least partially overlap each other in the vertical direction. This overlap may occur at a rear end of the image forming apparatus 1 in the depth direction (Y direction; a direction perpendicular to the plane of the sheet in FIG. 1). In some embodiments, the image former 115 and the rear projection 117 may be arranged side by side in the depth direction (Y direction) of the image forming apparatus.

With reference to FIGS. 2 to 4, the blower 136 includes multiple exhaust ports B1 to B9 (see FIGS. 5 and 6) in the first space W1 (the internal space W). The exhaust ports B1 to B9 exhaust air toward the first sheet stacker 134 from the vicinity of the first sheet ejection port H1, and are arranged side by side with spacing therebetween along a longitudinal direction (a width direction of the sheet P, the ±Y direction) of the first sheet ejection port H1.

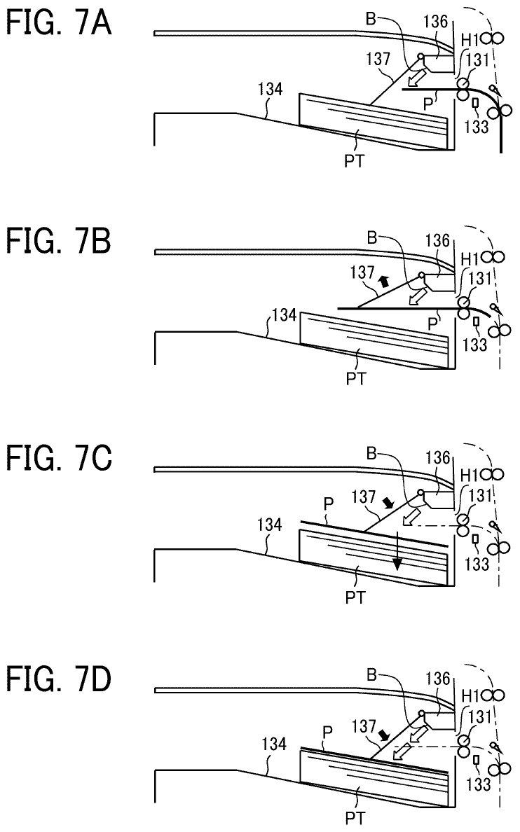

The blower 136 exhausts air drawn into an interior of the image forming apparatus 1 from the rear side toward the sheet P being ejected from the first sheet ejection port H1 (the sheet ejection port) onto the first sheet stacker 134 (the sheet stacker), and also toward the sheet P on the first sheet stacker 134 and a sheet bundle PT (see FIGS. 7A to 7D) on the first sheet stacker 134.

Specifically, the blower 136 includes a duct 136a and an intake fan 136x.

The duct 136a is formed so that the multiple exhaust ports B1 to B9 open downward.

With reference to exhaust ports B illustrated in FIG. 3, the nine exhaust ports B1 to B9 are formed in the duct 136a so as to open diagonally downward. The nine exhaust ports B1 to B9 are configured to discharge exhaust air diagonally downward from an upstream side toward a downstream side in the sheet ejection direction.

The duct 136a, which is located above the first sheet ejection port H1, is disposed to project downstream in the sheet ejection direction relative to the lateral projection 116. More specifically, the duct 136a is a hollow, substantially rectangular prism made of a resin material, and includes the multiple exhaust ports B1 to B9 formed in a C-chamfered portion on one edge thereof. The duct 136a is disposed not inside the image forming apparatus 1 (the lateral projection 116) but outside the image forming apparatus 1, that is, in the internal space W.

The intake fan 136x feeds air taken in from outside the image forming apparatus 1 into the duct 136a. the intake fan 136x draws in outside air through an intake port A (see FIG. 4) formed in a rear portion of the image forming apparatus 1, and feeds the drawn-in outside air into the duct 136a. Then, the air fed into the duct 136a is discharged toward the sheet P through the multiple exhaust ports B1 to B9.

The blower 136 cools the sheets P ejected onto the first sheet stacker 134, reducing the likelihood that the sheets P stacked on the first sheet stacker 134 stick together because the toner images on the sheets P act as a binder.

The blower 136 including the duct 136a is disposed outside the lateral projection 116 of the image forming apparatus 1 so as to project downstream in the sheet ejection direction, rather than being disposed inside the lateral projection 116. This makes it easier to provide, inside the lateral projection 116, a space for the second sheet ejection path K2, the sheet reversing path K3the duplex-printing conveyance path K4, the second sheet stacker 135, and the second ejection rollers 132 (the reversing rollers) inside the lateral projection 116.

The exhaust ports B of the duct 136a in the blower 136 do not open toward the first sheet ejection port H1 but open in a different direction. This prevents air from being blown onto the fixing device 120 through the first sheet ejection port H1, thereby avoiding a reduction in fixing efficiency.

As illustrated in FIG. 4, a portion of the duct 136a connected to the intake fan 136x passes through the rear projection 117. Alternatively, the portion of the duct 136a exposed to the internal space W may be detachable and may be fastened to the lateral projection 116 with screws

Alternatively, the intake fan 136x may be disposed in the internal space W on a front side of the rear projection 117 in the −Y direction, rather than being installed on the rear projection 117, with a clearance left between the intake fan 136x and the rear projection 117 so that the intake fan 136x can draw in air.

That is, the entire blower 136 including the intake fan 136x and the duct 136a may be accommodated in the internal space W. In this case, the blower 136 may be formed as a unit and detachably installed on the lateral projection 116 with screws.

With reference to FIG. 3, the image forming apparatus 1 includes a sheet detection sensor 133 (a detector) on the lateral projection 116. The sheet detection sensor 133 detects the presence or absence of the sheet P passing in the vicinity of the first sheet ejection port H1 (the sheet ejection port). The sheet detection sensor 133 is a reflective photosensor that optically detects whether the sheet P is present at that position (e.g., a detection point).

The sheet detection sensor 133 detects whether the sheets P are jammed at the detection point.

When multiple sheets P are continuously ejected from the first sheet ejection port H1, the intake fan 136x is controlled to start operating after a first predetermined time T1 elapses following detection of a leading end of a first sheet P by the sheet detection sensor 133. The intake fan 136x is controlled to stop operating after a second predetermined time T2 elapses following detection of a trailing end of a last sheet P by the sheet detection sensor 133.

Such control of the intake fan 136x reduces power consumption of the apparatus as compared with a case where the intake fan 136x operates continuously.

In the present embodiment, the first predetermined time T1 and the second predetermined time T2 are set to zero seconds. Alternatively, the first predetermined time T1 and the second predetermined time T2 may be set to other values.

The image forming apparatus 1 includes a hold-down member 137 that contacts an upper surface of a sheet P ejected from the first sheet ejection port H1 toward the first sheet stacker 134 and presses down on the sheet P.

The hold-down member 137 is a strip-shaped flexible sheet member made of a resin material such as polystyrene (PS) or polyethylene terephthalate (PET) and having a thickness of about 0.08 to 1.5 mm. The hold-down member 137 has a support portion 137a (a fixed end) fixed to the duct 136a by adhesive bonding, and is cantilever-supported by the duct 136a.

FIGS. 7A, 7B, 7C, and 7D are diagrams illustrating an operation in which sheets P are ejected onto the sheet stacker 134. Under normal operating conditions (i.e., when the hold-down member 137 is not in contact with the sheet P ejected from the first sheet ejection port H1), the hold-down member 137 assumes the posture indicated by the broken line in FIG. 3 (or the solid line in FIG. 1), with its free-end side unconstrained, when the sheet bundle PT stacked on the sheet stacker 134 has not reached the predetermined height. The hold-down member 137 assumes the posture indicated in FIG. 7A, with its free-end side in contact with the upper surface of the sheet bundle PT, when the sheet bundle PT stacked on the sheet stacker 134 has reached the predetermined height.

In contrast, during a hold-down operation in which the hold-down member 137 presses the sheet P, the hold-down member 137 elastically deforms from the posture under normal operating conditions and assumes the posture indicated by the solid lines in FIG. 3 and FIG. 7B, in which the free-end side of the hold-down member 137 contacts the sheet P ejected from the first sheet ejection port H1. The elastically deformed hold-down member 137 reduces the ejection speed of the sheet P ejected from the first sheet ejection port H1 and presses the sheet P downward toward the sheet stacker 134. This allows the sheet P ejected from the first sheet ejection port H1 to be stacked neatly on the sheet stacker 134.

FIG. 5 is a front view, as viewed from downstream in a sheet ejection direction, illustrating a relative position in a width direction of a sheet P between exhaust ports B of the blower 136 and hold-down members 137. Particularly with reference to FIG. 5, the hold-down member 137 includes two hold-down members arranged side by side in the width direction (Y direction) of the sheet P ejected from the first sheet ejection port H1. The two hold-down members are disposed on respective sides of a center reference R with substantially equal spacing from the center reference R. The center reference R is a target center position that does not change regardless of the sheet size.

With such an arrangement of the two hold-down members 137 at substantially equal spacing from the center reference R, the sheet P ejected from the first sheet ejection port H1 is pressed and held in a well-balanced manner in the width direction.

Specifically, the sheet P is pressed and held in a well-balanced manner in the width direction when (i) the spacing M (see FIG. 5) between the two hold-down members 137 is set to be 70% or less of the widthwise size N of the sheet P, and (ii) the two hold-down members 137 contact the sheet P within a range of 70% or less of the widthwise size N.

The two hold-down members 137 are arranged to contact a sheet Pmin having the minimum widthwise size (a minimum-size sheet Pmin) that can be ejected from the first sheet ejection port H1.

When the widthwise size (e.g., a widthwise length) of the minimum-size sheet Pmin (for example, a postcard size) is N1, the spacing M (or distance) between the two hold-down members 137 in the width direction is smaller than N1 (M<N1). The two hold-down members 137 are disposed within the widthwise size N1 in the width direction.

With this configuration, the hold-down members 137 can perform their hold-down function for sheets P of all sizes that can be ejected from the first sheet ejection port H1.

For example, even when the minimum-size sheet Pmin is a postcard-size sheet (100 mm) and a maximum-size sheet Pmax is an A3-size sheet (297 mm), and the spacing M between the two hold-down members 137 is set, as described above, based on the minimum size, the hold-down function of the two hold-down members 137 can be suitably exerted for sheets P ranging from the minimum size to the maximum size.

The hold-down members 137 are configured to operate within a region between two adjacent exhaust ports B4 and B5 (or B5 and B6) in the width direction of the multiple exhaust ports B1 to B9. This operation is indicated by the double-dashed bidirectional arrow in FIG. 3. In other words, the hold-down members 137 have their support portions 137a (fixed ends) fixed to the duct 136a within the region between two adjacent exhaust ports B4 and B5 (or B5 and B6) in the width direction among the multiple exhaust ports B1 to B9.

That is, as illustrated in FIG. 5, the hold-down members 137 are positioned in the width direction, which corresponds to the longitudinal direction of the first sheet ejection port H1, in the ±Y direction) so as not to overlap any of the exhaust ports B1 to B9. The hold-down members 137 and the exhaust ports B1 to B9 are configured such that air discharged from the exhaust ports B1 to B9 does not directly impinge on the hold-down members 137.

More specifically, as illustrated in FIG. 5, the exhaust ports B1 to B9 formed in the duct 136a are arranged at substantially equal intervals in the width direction to cool the maximum-sized sheet Pmax (the widthwise size of the sheet Pmax is N2 in FIG. 5). No exhaust port is provided at the two hold-down members 137, so that air discharged from the exhaust ports B1 to B9 does not impinge on the two hold-down members 137.

The nine exhaust ports B1 to B9 are configured to have the same shape and the same opening area. Four exhaust ports B1 to B4 are disposed outside one hold-down member 137 (the left one in FIG. 5) closer to the intake fan 136x in the width direction. One exhaust port B5 is disposed between the two hold-down members 137. Four exhaust ports B6 to B9 are disposed outside the other hold-down member 137 (the right one in FIG. 5) farther from the intake fan 136x in the width direction. The left hold-down member 137 is operable without being exposed to air discharged from the two exhaust ports B4 and B5 disposed on respective sides of the left hold-down member 137. In other words, the two exhaust ports B4 and B5 are provided with the left hold-down member 137 interposed therebetween. Similarly, the right hold-down member 137 can operate without being hit by air discharged from the two exhaust ports B5 and B6 disposed on respective sides of the right hold-down member 137.

This configuration allows the hold-down members 137 to avoid fluttering due to air discharged from the blower 136 (the exhaust ports B1 to B9), thus preventing the hold-down members 137 from failing to function as hold-down members 137.

As a result, the sheets P ejected from the first sheet ejection port H1 can be stacked on the sheet stacker 134 neatly and properly without sticking together due to heat.

FIG. 6 is a cross-sectional view of the duct 136a taken along line F-F in FIG. 5. With reference to FIGS. 5 and 6, the two exhaust ports B4 and B5 (or B5 and B6) disposed on the respective sides of the hold-down member 137 are formed such that at least one of the exhaust ports is configured to direct discharged air obliquely toward a center of a region between the two exhaust ports B4 and B5 (or B5 and B6) on the sheet stacker 134.

More specifically, of the two exhaust ports B4 and B5 with the left hold-down member 137 (the left one in FIG. 5) interposed therebetween, the right exhaust port B5 is formed to discharge air straight toward the same widthwise position on the sheet stacker 134, similarly to the three left exhaust ports B1 to B3 and the three right exhaust ports B7 to B9. The right exhaust ports B5 is located between the two hold-down members 137.

Specifically, as illustrated in FIG. 6, a guide wall C5 directs air that is delivered from the intake fan 136x and flows substantially in a horizontal direction within the duct 136a, downward. The guide wall C5 corresponds to the exhaust port B5 at the center of the duct 136a. The guide wall C5 extends vertically, similar to the three guide walls C1 to C3 on the left side and the three guide walls C7 to C9 on the right side.

In contrast, a guide wall C4 corresponding to the exhaust port B4 located to the left of the left hold-down member 137 is inclined toward a central portion of a region on the sheet stacker 134, the region corresponding to the region between the exhaust ports B4 and B5 in the width direction. In other words, the guide wall C4 is inclined downward from the left to the right as illustrated in FIG. 6. A guide wall C6 corresponding to the exhaust port B6 located to the right of the right hold-down member 137 is inclined toward a central portion of a region on the sheet stacker 134, the region corresponding to the region between the exhaust ports B5 and B6 in the width direction. In other words, the guide wall C6 is inclined downward from the right to the left as illustrated in FIG. 6.

With such a configuration of the adjacent exhaust ports B4 and B5 (alternatively, the exhaust ports B5 and B6) on the respective sides of the hold-down member 137, an area on the ejected sheet P corresponding to a widthwise range in which the hold-down member 137 is located and no exhaust port is provided can be actively cooled. Thus, the sheet P ejected from the first sheet ejection port H1 can be cooled in a well-balanced and substantially uniform manner across the width direction and stacked on the sheet stacker 134 properly without adhering due to heat.

Note that, when two or more exhaust ports are provided between two hold-down members 137, both of two exhaust ports on the respective sides of one hold-down member 137 are configured to direct discharged air obliquely toward a center of a region on the sheet stacker 134 between the two exhaust ports.

As illustrated in FIGS. 7A to 7D, when the sheet P is continuously ejected from the first sheet ejection port H1, the blower 136 (intake fan 136x) is kept operating (ON), and air is ejected from the exhaust ports B (i.e., B1 to B9), cooling the sheet P being ejected and the sheet bundle PT stacked on the sheet stacker 134.

During this operation, the sheet P ejected from the first sheet ejection port H1 is stacked onto the sheet bundle PT on the sheet stacker 134 while being pressed and held by the hold-down member 137.

As described above, the hold-down member 137 can maintain the hold-down function while the blower 136 is kept operating during ejection of the sheet P, because the blower 136 is configured such that air exhausted from the blower 136 does not impinge on the hold-down member 137.

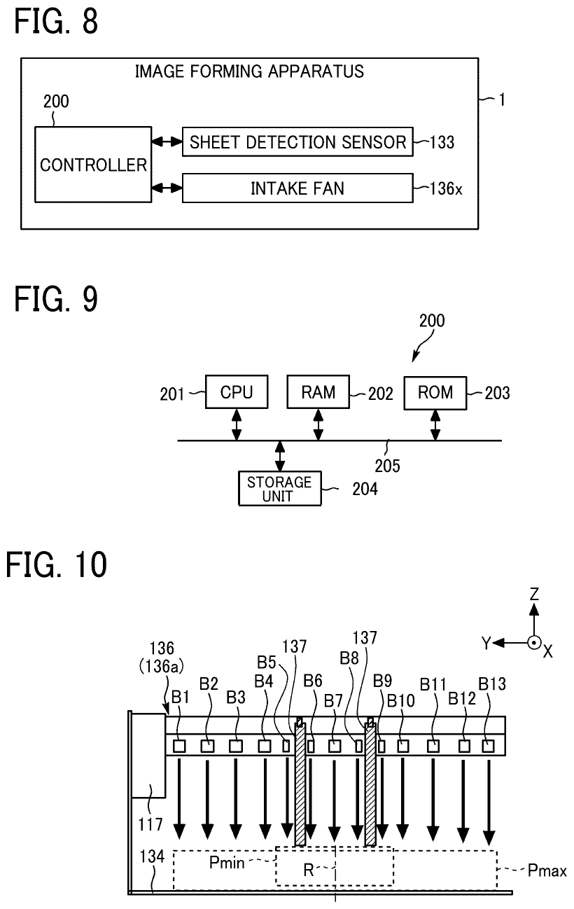

FIG. 8 is a block diagram of a part of a configuration of the image forming apparatus 1. The image forming apparatus 1 that operates as described above is achieved by control performed by a controller 200, such as control of the intake fan 136x, based on detection results of the sheet detection sensor 133.

FIG. 9 is a diagram illustrating a configuration of a control system of the image forming apparatus 1. As illustrated in FIG. 9, the controller 200 includes a central processing unit (CPU) 201, a random-access memory (RAM) 202, a read-only memory (ROM) 203, and a storage unit 204, all of which are connected via a bus 205.

The CPU 201 is a processor and controls the overall operation of the image forming apparatus 1. The RAM 202 is a volatile storage medium that can read and write information at high speed. When the CPU 201 processes information, the RAM 202 is used as the work area for the CPU 201. The ROM 203 is a non-volatile read-only storage medium and stores programs such as firmware. The storage unit 204 is a non-volatile storage medium that allows information to be read and written, and stores an operating system (OS), various control programs, and application programs. The storage unit 204 is, for example, a solid-state drive (SSD) or a hard disk drive (HDD).

### Modification 1

FIG. 10 is a front view, as viewed from downstream in a sheet ejection direction, illustrating a relative position in a width direction of a sheet P between exhaust ports B1 to B13 of a blower 136 and a hold-down member 137 in an image forming apparatus 1 according to Modification 1. As illustrated in FIG. 10, in a duct 136a of the blower 136 of the image forming apparatus 1 according to Modification 1, two adjacent exhaust ports B5 and B6 (or B8 and B9), with the hold-down member 137 interposed therebetween, have an opening size (or an opening area) (specifically, a length in the width direction) that is smaller than those of the other exhaust ports B1 to B4, B7, and B10 to B13 among multiple exhaust ports (the thirteen exhaust ports B1 to B13 are provided in Modification 1), and are formed to exhaust air straight, without being inclined, toward the same positions in the width direction on the sheet stacker 134.

The multiple exhaust ports B1 to B13 arranged in this manner are also configured to prevent the discharged air from directly impinging on the hold-down member 137. The hold-down member 137 operates in a region between the two exhaust ports B5 and B6 (or the exhaust ports B8 and B9) in the width direction.

Furthermore, the two exhaust ports B5 and B6 (or the two exhaust ports B8 and B9) are positioned closer to the hold-down member 137 in the width direction. In addition, the pitch between the two exhaust ports B5 and B6 (or the two exhaust ports B8 and B9) is shorter than the pitch between adjacent exhaust ports among the other exhaust ports B1 to B4 and B10 to B13.

This configuration enables the sheet P ejected from the first sheet ejection port H1 to be cooled in a well-balanced and substantially uniform manner across the width direction and stacked on the sheet stacker 134 properly without adhering due to heat.

### Modification 2

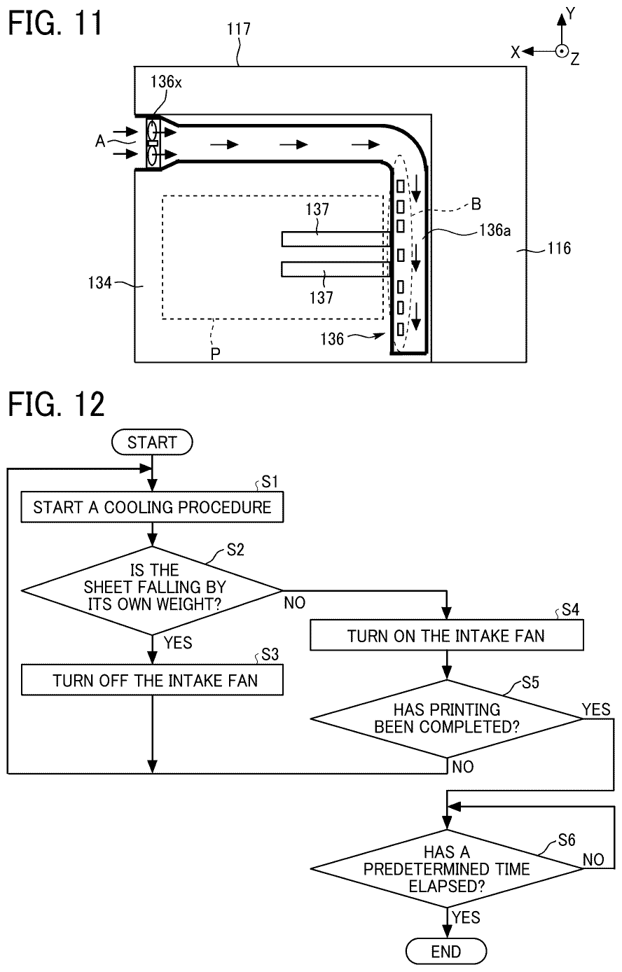

FIG. 11 is a top view of airflow in a duct 136a of a blower 136, according to Modification 2 As illustrated in FIG. 11, the blower 136 according to Modification 2 draws in air at a lateral side of an image forming apparatus 1, rather than from the rear side of the image forming apparatus 1.

The blower 136 is disposed in the internal space W in front of the rear projection 117 (in the −Y direction) so as to face the rear projection 117. The blower 136 draws in air from a lateral side (the left side in FIG. 11) of the image forming apparatus 1 by the intake fan 136x. The blower 136 causes the air to flow along the duct 136a in the −X direction, then through a curved duct portion, and then through a duct portion extending in the −Y direction, and blows the air from the multiple exhaust ports B toward the sheet P.

Using the blower 136 configured as described above, the sheet P ejected from the first sheet ejection port H1 is placed properly on the sheet stacker 134 without sticking due to heat, because no exhaust port is provided at a widthwise position at which the hold-down member 137 is provided.

### Modification 3

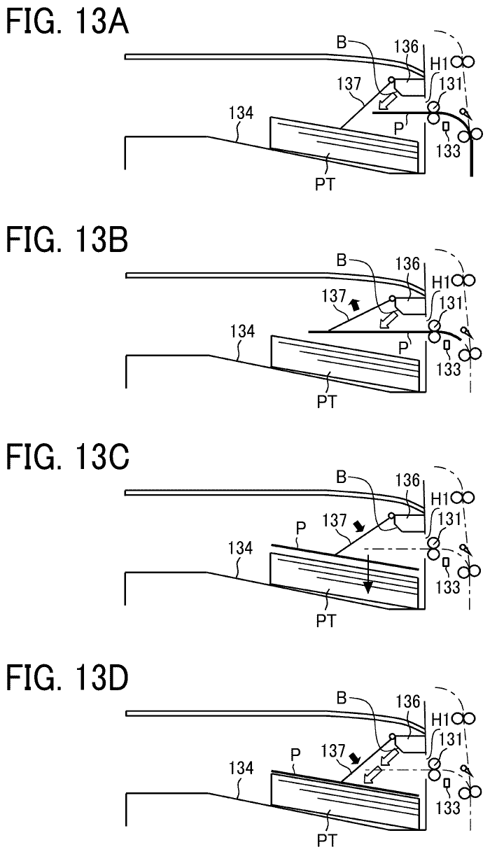

FIG. 12 is a flowchart of control performed in an image forming apparatus 1 according to Modification 3. FIGS. 13A, 13B, 13C, and 13D are diagrams illustrating an operation of the image forming apparatus 1 according to Modification 3 during execution of the control of FIG. 12. As illustrated in FIGS. 12, 13A, 13B, 13C, and 13D, in an image forming apparatus 1 according to Modification 3, a blower 136 is controlled to stop exhausting air from the multiple exhaust ports B1 to B9 during a period from when a trailing end of the sheet P on an upstream side in a sheet ejection direction is sent out from a nip of the first ejection roller pair 131 (an ejection roller pair) until the sheet P is placed on the sheet stacker 134.

The blower 136 exhausts air from the multiple exhaust ports B1 to B9 during periods other than the period.

That is, as illustrated in FIGS. 13A and 13B, the intake fan 136x is operated (ON) while the sheet P is nipped and conveyed by the first ejection roller pair 131, and, as illustrated in FIG. 13D, is also operated (ON) after the sheet P is stacked on the sheet stacker 134. However, as illustrated in FIG. 13C, the intake fan 136x is stopped (OFF) while the trailing end of the sheet P passes the position of the first ejection roller pair 131 and the sheet P falls toward the sheet stacker 134 under its own weight while suspended, as illustrated in FIG. 13C.

Such control is performed because, as illustrated in FIG. 13C, when the sheet P is airborne, the sheet P is free from constraint by the first ejection roller pair 131, and the hold-down member 137 can exert its hold-down function. the blower 136 is stopped while the sheet P is airborne so that the hold-down function of the hold-down member 137 is not hindered. Except during that period, the blower 136 is operated to sufficiently cool the sheet P.

The multiple sheets including the sheet is nipped, one by one from a first sheet to n-th sheet, at a nip, and the multiple sheets are conveyed toward the sheet stacker (134). The circuitry is configured to repeat, one by one from the first sheet to the n-th sheet, turning off the blower (136) to stop exhausting air from the multiple exhaust ports during a time period from a point at which a trailing end of the sheet is fed out from the nip to a point at which the sheet has been stacked on the sheet stacker (134).

FIG. 12 is a flowchart of a process for controlling the blower 136.

First, the controller 200 starts a cooling procedure in response to receiving a print job (step S1) and determines whether a sheet P is being ejected from the first sheet ejection port H1 and falling toward the sheet stacker 134 by its own weight (step S2). The controller 200 determines such a state (the sheet P is falling by its own weight) based on detection by the sheet detection sensor 133 (see FIG. 3) that the trailing end of the sheet P has passed the sheet detection sensor 133. When the controller 200 determines that the sheet P is falling under its own weight (YES in step S2), the controller 200 turns off the intake fan 136x and keeps the intake fan 136x off until a time at which the falling is expected to be completed (step S3).

When the controller 200 determines that the sheet P is not falling by its own weight (NO in step S2), the controller 200 turns on the intake fan 136x (step S4). In step S5, the controller 200 determines whether a series of print jobs has been completed. When the controller 200 determines that the series of print jobs has not been completed (NO in step S5), the controller 200 repeats the processes from step S1. When the controller 200 determines that the series of print jobs has been completed (YES in step S5), the controller 200 waits until a predetermined time has elapsed and then turns off the intake fan 136x (step S6).

Such a control also enables the sheets P ejected from the first sheet ejection port H1 to be stacked on the sheet stacker 134 properly without sticking together due to heat. In particular, in Modification 3, no exhaust port is provided at the widthwise position of the hold-down member 137, and the blower 136 is stopped while the sheet P is falling under its own weight, thus enhancing the hold-down function of the hold-down member 137 and making the effects of the present disclosure more readily exerted.

As described above, the image forming apparatus 1 includes a image former 115 that forms an image on a sheet P, and a sheet stacker 134 disposed above the image former 115, to stack the sheet P after the image has been formed by the image former 115. The sheet stacker 134 includes a tray. The image forming apparatus 1 further includes a lateral projection 116 that includes a first sheet ejection port H1 for ejecting the sheet P toward the sheet stacker 134. The lateral projection 116 projects upward from the side portion of the image former 115 to be adjacent to the sheet stacker 134. The image forming apparatus 1 further includes a blower 136 and a hold-down member 137. The blower 136 has multiple exhaust ports B1 to B9 arranged at intervals in the width direction. The multiple exhaust ports B1 to B9 are configured to exhaust air from a region on the first sheet ejection port H1 toward the sheet stacker 134. The hold-down member 137 contacts an upper surface of the sheet P ejected from the first sheet ejection port H1 toward the sheet stacker 134 and presses the sheet P from above. The hold-down member 137 operates in a region between the two adjacent exhaust ports B4 and B5 (or the exhaust ports B5 and B6) in the width direction, among the multiple exhaust ports B1 to B9.

This allows the sheet P ejected from the first sheet ejection port H1 to be stacked on the sheet stacker 134 properly without sticking due to heat.

In the present embodiment, the above-described configuration is applied to the image forming apparatus 1 in which the rear projection 117 is formed in addition to the lateral projection 116. However, the above-described configuration is also applicable to an image forming apparatus in which the rear projection 117 is not formed and the lateral projection 116 is formed.

In the present embodiment, the above-described configuration is applied to the image forming apparatus 1 in which two hold-down members 137 are provided. However, the above-described configuration is also applicable to an image forming apparatus in which one hold-down member is provided, and to an image forming apparatus in which three or more hold-down members are provided.

With such a configuration, effects similar to those described above are also achieved.

The present disclosure is not limited to the above-described embodiment, modifications, and variations, and the configuration of the present embodiment can be appropriately modified other than suggested in the above embodiment, modifications, and variations within a scope of the technological concept of the present disclosure. The number, position, and shape of the components described above are not limited to those embodiments described above. Desirable number, position, and shape can be determined to perform the present disclosure.

In the present specification, directions (sides) and surfaces such as a “rear side,” a “lateral side/side portion,” a “front side,” and a “rear surface” are defined with reference to a configuration in which an operator such as a user faces the image forming apparatus 1 to perform operation, and a side facing the operator is defined as a “front side” or a “front.”

Aspects of the present disclosure are as follows, for example.

### Aspect 1

An image forming apparatus (1) includes an image former (115), a sheet stacker (134), a lateral projection (116), a blower (136), and a pressing member (137). The image former (115) forms an image on a sheet. The sheet stacker (134) is disposed above the image former (115) in a vertical direction (Z). The sheet stacker (134) stacks the sheet having the image on the sheet. The lateral projection (116) projects upward from the image former (115) in the vertical direction (Z), and is disposed at a side portion of the image former (115) in a lateral direction (X) perpendicular to the vertical direction (Z) and is disposed adjacent to the sheet stacker (134) in the lateral direction. The lateral projection (116) includes a sheet ejection port (H1) to eject the sheet to the sheet stacker (134) in the lateral direction. The blower (136) includes multiple exhaust ports (B1 to B9) arranged side by side at intervals in a width direction perpendicular to the vertical direction and the lateral direction. The multiple exhaust ports (B1-B9) are disposed above the sheet ejection port (H1) to exhaust air downward to the sheet stacker (134). The pressing member (137) contacts and presses, an upper surface of the sheet ejected from the sheet ejection port (H1) to the sheet stacker (134), from above in the vertical direction. The pressing member (137) is disposed within an operating region between two adjacent exhaust ports among the multiple exhaust ports (B1 to B9) in the width direction.

### Aspect 2

In the image forming apparatus according to Aspect 1, the pressing member (137) is offset from each of the two adjacent exhaust ports (B1 to B9) within the operating region in the width direction.

### Aspect 3

In the image forming apparatus according to Aspect 1 or 2, the sheet stacker has a central portion corresponding to a center of the operating region in the width direction, the central portion disposed directly below the pressing member, and at least one of the two adjacent exhaust ports (B4, B5/B5, B6) exhausts the air in a direction inclined toward the central portion.

### Aspect 4

In the image forming apparatus according to Aspect 1 or 2, each of the multiple exhaust ports other than the two adjacent exhaust ports has a first opening area. Each of the two adjacent exhaust ports (B4, B5/B5, B6) has a second opening area smaller than the first opening area. Each of the two adjacent exhaust ports exhaust air straight downward in the vertical direction, toward the positions of the sheet stacker (134) corresponding to the two adjacent exhaust ports in the width direction.

### Aspect 5

The image forming apparatus according to any one of Aspects 1 to 4 further incudes two pressing members (137a) including the pressing member (137). The two pressing members (137a) are arranged in parallel, with a center reference (R), of the sheet (P) on the sheet stacker (134), positioned between the two pressing members in the width direction.

### Aspect 6

In the image forming apparatus according to Aspect 5, the two pressing members (137) are spaced apart from each other by a distance (M) in the width direction. The distance (M) is smaller than a widthwise length (N1) of the sheet having a minimum size in the width direction, to allow the two pressing members to contact an upper surface of the sheet having the minimum size in the width direction.

### Aspect 7

In the image forming apparatus according to any one of Aspects 1 to 6, the blower (136) includes a duct (136a) having the multiple exhaust ports (B1 to B9) opening downward in the vertical direction and projecting downstream in the lateral direction relative to the lateral projection (116), above the sheet ejection port (H1) in the vertical direction; and an intake fan (136x) to feed air drawn from outside the image forming apparatus into the duct (136a).

### Aspect 8

In the image forming apparatus according to Aspect 7, the pressing member (137) includes a flexible sheet cantilever-supported by the duct (136a).

### Aspect 9

The image forming apparatus according to any one of Aspects 1 to 8, further includes an ejection roller pair (131) at the sheet ejection port (H1) to nip multiple sheets including the sheet, one by one from a first sheet to n-th sheet, at a nip and convey the multiple sheets toward the sheet stacker (134); and circuitry configured to repeat, one by one from the first sheet to the n-th sheet, turning off the blower (136) to stop exhausting air from the multiple exhaust ports during a time period from a point at which a trailing end of the sheet is fed out from the nip to a point at which the sheet has been stacked on the sheet stacker (134).

### Aspect 10

In the image forming apparatus according to Aspect 9, the circuitry is further configured to turn on the blower (136) to exhaust air from the multiple exhaust ports during another time period other than the time period.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

1. An image forming apparatus comprising:
an image former to form an image on a sheet;
a sheet stacker disposed above the image former in a vertical direction, the sheet stacker to stack the sheet having the image on the sheet;
a lateral projection:
projecting upward from the image former in the vertical direction;
disposed at a side portion of the image former in a lateral direction perpendicular to the vertical direction;
disposed adjacent to the sheet stacker in the lateral direction; and
including a sheet ejection port to eject the sheet to the sheet stacker in the lateral direction;
a blower including multiple exhaust ports arranged side by side at intervals in a width direction perpendicular to the vertical direction and the lateral direction, the multiple exhaust ports disposed above the sheet ejection port to exhaust air downward to the sheet stacker; and
a pressing member to:
contact and press, an upper surface of the sheet ejected from the sheet ejection port to the sheet stacker, from above in the vertical direction, and
disposed within an operating region between two adjacent exhaust ports among the multiple exhaust ports in the width direction.

2. The image forming apparatus according to claim 1, wherein:
the pressing member is offset from each of the two adjacent exhaust ports within the operating region in the width direction.

3. The image forming apparatus according to claim 1, wherein:
the sheet stacker has a central portion corresponding to a center of the operating region in the width direction, the central portion disposed directly below the pressing member, and
at least one of the two adjacent exhaust ports exhausts the air in a direction inclined toward the central portion.

4. The image forming apparatus according to claim 1, wherein:
each of the multiple exhaust ports other than the two adjacent exhaust ports has a first opening area,
each of the two adjacent exhaust ports has a second opening area smaller than the first opening area, and
each of the two adjacent exhaust ports exhaust air straight downward in the vertical direction, toward the positions of the sheet stacker corresponding to the two adjacent exhaust ports in the width direction.

5. The image forming apparatus according to claim 1, further comprising:
two pressing members including the pressing member,
wherein the two pressing members are arranged in parallel, with a center reference, of the sheet on the sheet stacker, positioned between the two pressing members in the width direction.

6. The image forming apparatus according to claim 5, wherein:
the pressing members are spaced apart from each other by a distance in the width direction, the distance being smaller than a widthwise length of the sheet having a minimum size in the width direction, to allow the two pressing members to contact an upper surface of the sheet having the minimum size in the width direction.

7. The image forming apparatus according to claim 1, wherein:
the blower includes:
a duct:
having the multiple exhaust ports opening downward in the vertical direction; and
projecting downstream in the lateral direction relative to the lateral projection, above the sheet ejection port in the vertical direction; and
an intake fan to feed air drawn from outside the image forming apparatus into the duct.

8. The image forming apparatus according to claim 7,
the pressing member includes a flexible sheet cantilever-supported by the duct.

9. The image forming apparatus according to claim 1, further comprising:
an ejection roller pair at the sheet ejection port to:
nip multiple sheets including the sheet, one by one from a first sheet to an n-th sheet, at a nip; and
convey the multiple sheets toward the sheet stacker; and
circuitry configured to repeat, one by one from the first sheet to the n-th sheet:
turning off the blower to stop exhausting air from the multiple exhaust ports during a time period from a point at which a trailing end of the sheet is fed out from the nip, to a point at which the sheet has been stacked on the sheet stacker.

10. The image forming apparatus according to claim 9, wherein:
the circuitry is further configured to turn on the blower to exhaust air from the multiple exhaust ports during another time period other than the time period.
